(19) United States
(12) Patent Application Publication
(10) Pub. No.: US 2017/0073068 A1
(43) Pub. Date: Mar. 16, 2017

(54) SINGLE ACTUATOR BLADE FOLD LINKAGE

(71) Applicant: Sikorsky Aircraft Corporation, Stratford, CT (US)

(72) Inventor: Frank P. D' Anna, Seymour, CT (US)

(21) Appl. No.: 15/122,997

(22) PCT Filed: Mar. 3, 2014
(86) PCT No.: PCT/US2014/019787

§ 371 Date: Sep. 1, 2016

(51) Int. Cl. B64C 27/50

(52) U.S. Cl. CPC B64C 27/50

(57) ABSTRACT

An actuation assembly configured for use on a rotor blade having a first section and a second section, the second section being configured to rotate between an aligned position and a rotated position relative to the first section. The actuation assembly includes an actuator having a movable portion. A linkage assembly, coupled to the movable portion, includes a toggle link having a first end and a second end, a first group of links coupled to the first end, and a second group of links coupled to the second end. The first group of links is configured to move a locking pin between a locked position in which the second section cannot rotate and an unlocked position in which the second section can rotate. The second group of links is configured to rotate the second section of the rotor blade between the aligned position and the rotated position.

### BACKGROUND OF THE INVENTION

Exemplary embodiments of the invention relate to a blade fold assembly for a rotary wing aircraft, and more particularly, to an actuator and linkage for operating a blade fold system.

The flight capabilities of rotary-wing aircrafts make them effective for a wide variety of missions; however, operation of rotary-wing aircrafts in certain environments may be limited by the overall structural envelopes thereof. The radial dimensions of a rotary-wing aircraft main rotor assembly results in a rotary-wing aircraft having a relatively large structural envelope which may impact its utility in some environments. For example, space on a ship or vessel is generally at a premium and the structural envelope of a rotary wing aircraft may require a significant allocation of such limited space. Furthermore, strategic and tactical considerations in the military utilization of rotary-wing aircrafts has led to a requirement for rotary-wing aircrafts having main rotor assemblies that may be readily reconfigured for rapid deployment, routine transport, and/or stowage by reducing the structural envelope.

One way to reduce the structural envelope of rotary-wing aircraft to facilitate rapid deployment, routine transport, stowage, and reduce the vulnerability thereof to environmental conditions is to design the main rotor assembly so that the main rotor blades fold relative to the main rotor hub. However, conventional blade folding systems are cumbersome and are susceptible to drag, thereby decreasing the efficiency of the rotary wing aircraft in flight. Existing automatic blade folding systems include two actuators, a first actuator configured to rotate a rotor blade between an operational position and a rotated position and a second actuator configured to selectively lock the blade in the operational position. Systems having two actuators require a significant number of components, including a plurality of hydraulic lines and a sequence valve. As a result of the complexity, the automatic blade folding system creates additional aerodynamic drag while increasing the overall cost of the rotary wing aircraft.

### BRIEF DESCRIPTION OF THE INVENTION

According to one embodiment of the invention, an actuation assembly configured for use on a rotor blade having a first section and a second section, the second section being configured to rotate between an aligned position and a rotated position relative to the first section. The actuation assembly includes an actuator having a movable portion. A linkage assembly, coupled to the movable portion, includes a toggle link having a first end and a second end, a first group of links coupled to the first end, and a second group of links coupled to the second end. The first group of links is configured to move a locking pin between a locked position in which the second section cannot rotate and an unlocked position in which the second section can rotate. The second group of links is configured to rotate the second section of the rotor blade between the aligned position and the rotated position.

In addition to one or more of the features described above, or as an alternative, in further embodiments the actuator is a linear actuator.

In addition to one or more of the features described above, or as an alternative, in further embodiments upon operation of the actuator, the toggle link is configured to move either the first group of links or the second group of links.

In addition to one or more of the features described above, or as an alternative, in further embodiments the second section of the rotor blade is retained in the aligned position when the locking pin is in a locked position.

In addition to one or more of the features described above, or as an alternative, in further embodiments the toggle link is configured to move the first group of links and the second group of links sequentially when the actuator is operated in a first direction.

In addition to one or more of the features described above, or as an alternative, in further embodiments the toggle link is configured to move the second group of links and the first group of links sequentially when the actuator is operated in a second direction.

According to another embodiment of the invention, a rotor blade which rotates about a rotor hub is provided including a first section and a second section. The first section is configured to mount to the rotor hub and includes a cavity and an opening extending perpendicular to and through the cavity. The second section includes a first arm having a second opening. The second section being rotatably coupled to the first section and configured to rotate between an aligned position and a rotated position. When the second section is in the aligned position, the first arm is arranged within the cavity such that the first opening and the second opening are generally aligned. An actuation assembly includes an actuator having a movable portion configured to move in a first direction and a second opposite direction. A linkage assembly is operably coupled to the movable portion of the actuator. The linkage assembly includes a toggle link having a first end and a second end, a first group of links coupled to the first end, and a second group of links coupled to the second end. The first group of links is configured to move a locking pin between a locked position in which the second section cannot rotate and an unlocked position in which the second section can rotate. The second group of links is configured to rotate the second section of the rotor blade between the aligned position and the rotated position when the locking pin is in the unlocked position.

In addition to one or more of the features described above, or as an alternative, in further embodiments the actuator is a linear actuator.

In addition to one or more of the features described above, or as an alternative, in further embodiments the locking pin extends through the aligned first opening and second opening when in the locked position.

In addition to one or more of the features described above, or as an alternative, in further embodiments the locking pin is configured to retain the second section of the rotor blade in the aligned position.

In addition to one or more of the features described above, or as an alternative, in further embodiments the toggle link is configured to move either the first group of links or the second group of links upon operation of the actuator.

In addition to one or more of the features described above, or as an alternative, in further embodiments the actuator is configured to move the second group of links only when the locking pin is in the unlocked position.

In addition to one or more of the features described above, or as an alternative, in further embodiments the actuator is configured to move the first group of links only when the second section is in the aligned position.

In addition to one or more of the features described above, or as an alternative, in further embodiments a blocking mechanism is arranged within the cavity. When in a neutral position, the blocking mechanism is configured to limit movement of the locking pin from the unlocked position to the locked position when the second section is in a rotated position.

In addition to one or more of the features described above, or as an alternative, in further embodiments the blocking mechanism includes a plunger configured to slide within the cavity and a biasing mechanism configured to bias the plunger to the neutral position.

According to another embodiment of the invention, a method of folding a rotor blade having a first section and a second section is provided. The second section of the rotor blade is rotatably coupled to the first section and is configured to rotate about a blade fold axis between an aligned position and a rotated position. The rotor blade further includes an actuation assembly including an actuator coupled to a linkage assembly having a first group of links and a second group of links. The method includes pivoting the first group of links to move a locking pin from a locked position in which the second section cannot rotate to an unlocked position in which the second section can rotate. The second group of links is rotated to move the second section of the rotor blade about the blade axis from the aligned position to the rotated position.

In addition to one or more of the features described above, or as an alternative, in further embodiments, a first movement of the actuator causes the first group of links to pivot and a second movement of the actuator causes the second group of links to rotate.

In addition to one or more of the features described above, or as an alternative, in further embodiments the second group of links are pivoted to rotate the second section of the rotor blade about the blade fold axis from the rotated position to the aligned position. The first group of links are pivoted to move the locking pin from the unlocked position to the locked position.

Technical effects include the ability to perform rotor blade lock pin actuation and rotor blade fold actuation using a single actuator.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side view of an example of a rotary wing aircraft;

FIG. 2 is an cross-sectional view of a main rotor system of the aircraft illustrated in FIG. 1;

FIG. 3 is a top view of a rotor blade in an aligned, locked position according to an embodiment of the present invention;

FIG. 4 is a top view of a rotor blade an aligned, unlocked position according to an embodiment of the present invention;

FIG. 5 is a top view of a rotor blade a partially rotated, unlocked position according to an embodiment of the present invention;

FIG. 6 is a top view of a rotor blade in a rotated unlocked position according to an embodiment of the present invention;

FIG. 7 is a top view of a first group of links of a linkage assembly of FIGS. 3-6 according to an embodiment of the invention; and

FIG. 8 is a top view of a second group of links of a linkage assembly of FIGS. 3-6 according to an embodiment of the invention.

The detailed description explains embodiments of the invention, together with advantages and features, by way of example with reference to the drawings.

### DETAILED DESCRIPTION OF THE INVENTION

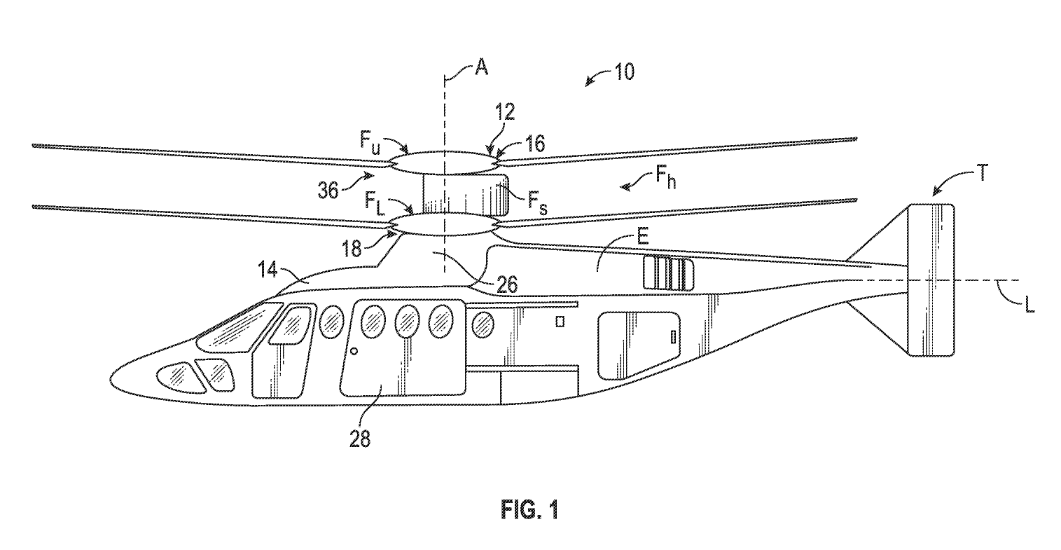

FIG. 1 illustrates an exemplary vertical takeoff and landing (VTOL) rotary-wing aircraft 10 having a dual, counter-rotating, coaxial rotor system 12 which rotates about an axis of rotation A. The aircraft 10 includes an airframe 14 which supports the dual, counter rotating, coaxial rotor system 12 as well as an optional translational thrust system T which provides translational thrust generally parallel to an aircraft longitudinal axis L. Although a particular aircraft configuration is illustrated in the disclosed embodiment, other counter-rotating, coaxial rotor systems and non-coaxial rotor systems will also benefit from the present invention.

A main gearbox 26 which may be located above the aircraft cabin drives the rotor system 12. The translational thrust system T may be driven by the same main gearbox 26 which drives the rotor system 12. The main gearbox 26 is driven by one or more engines (illustrated schematically at E). As shown, the main gearbox 26 may be interposed between the gas turbine engines E, the rotor system 12 and the translational thrust system T.

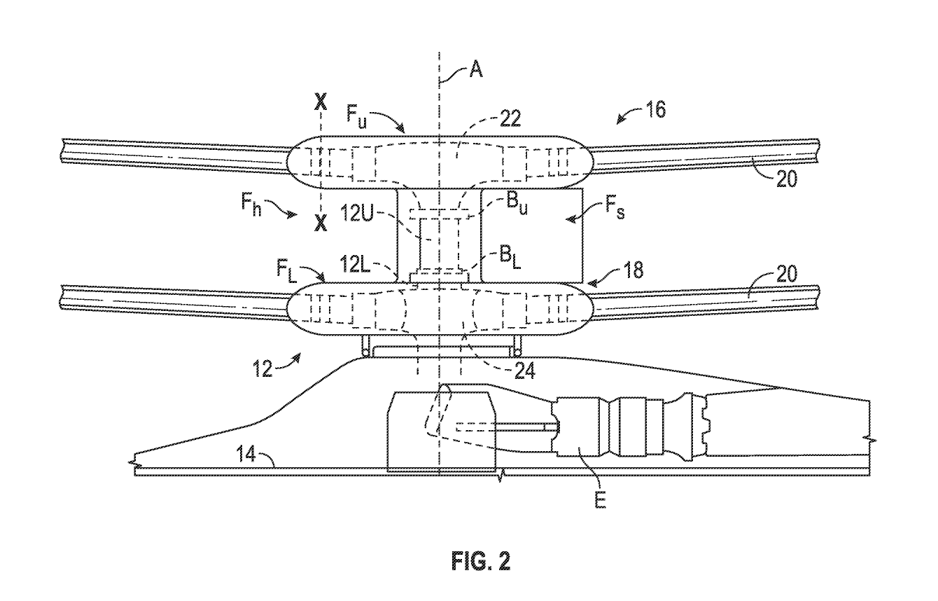

Referring to FIG. 2, the dual, counter-rotating, coaxial rotor system 12 includes an upper rotor system 16 and a lower rotor system 18. Each rotor system 16, 18 includes a plurality of rotor blade assemblies 20 mounted to a rotor hub assembly 22, 24 for rotation about a rotor axis of rotation A. A plurality of the main rotor blade assemblies 20 project radially outward from the hub assemblies 22, 24. Any number of main rotor blade assemblies 20 may be used with the rotor system 12.

While not required in all aspects, the shown rotor system 12 also includes a rotor hub fairing system Fh generally located between and around the upper and lower rotor systems 16, 18 such that the rotor hub assemblies 22, 24 are at least partially contained therein. The rotor hub fairing system Fh preferably includes an upper hub fairing Fu, a lower hub fairing Fl and a shaft fairing Fs there between. The shaft fairing Fs is preferably attached to the counter-rotating, coaxial rotor system 12 through a bearing arrangement Bu, Bl such that the shaft fairing Fs is aligned with the relative wind in forward flight but may be free to pivot during low speed maneuvering. The upper bearing Bu and the lower bearing Bl are respectively located adjacent an upper portion and a lower portion of the shaft fairing Fs. The upper bearing Bu is preferably attached to one rotor shaft 12U while the lower bearing Bl attached to the other rotor shaft 12L such that the bearings counter-rotate and net bearing drag is relatively low.

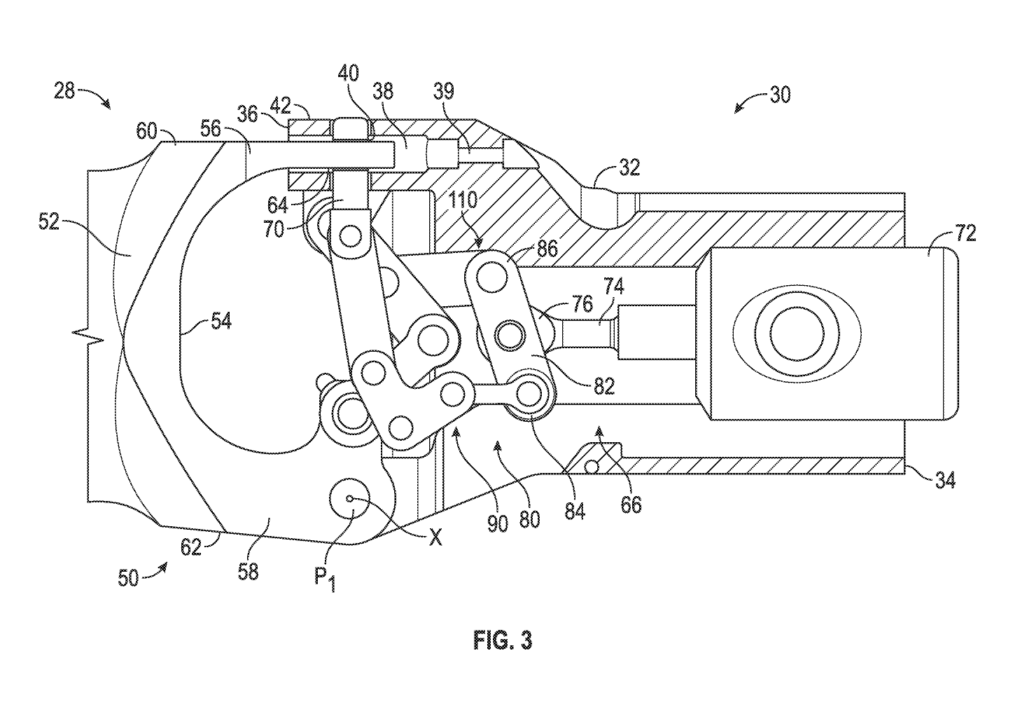

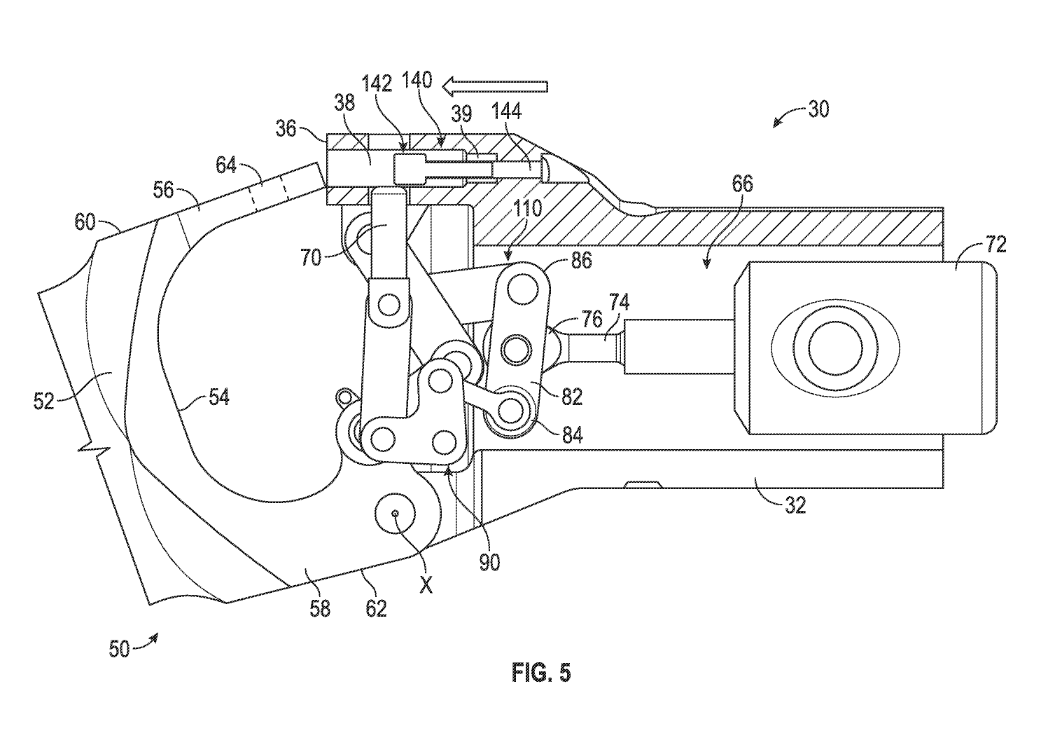

Referring now to FIGS. 3-8, at least one of the rotor blade assemblies 20 includes a rotor blade 28 configured to fold about a fold axis X (FIG. 2), generally perpendicular to the blade chord. The rotor blade 20 is divided into a first section 30 and a complementary second section 50. The first section 30 includes an attachment member or spindle 32, a first end 34 of which is mounted to a rotor hub, such as rotor hub 22 or 24 for example, such that the attachment member 32 extends radially outward therefrom. Formed in the second, opposite end 36 of the spindle 32 is an inwardly extending cavity 38. A first opening 40, arranged generally perpendicular to the cavity 38, extends through a portion of the spindle 32 including the cavity 38. In one embodiment, the first opening 40 extends beyond the cavity 38 to a first side 42 of the spindle 32.

The second section 50 includes the main structural component of the rotor blade 28, the blade spar 52. The end 54 of the blade spar 52 adjacent the spindle 32 includes a first arm 56 and a second arm 58 generally positioned adjacent a first and second side 60, 62 of the blade spar 52, respectively. The first arm 56 is complementary in size and shape to the cavity 38 formed in the free end 36 of the spindle 32.

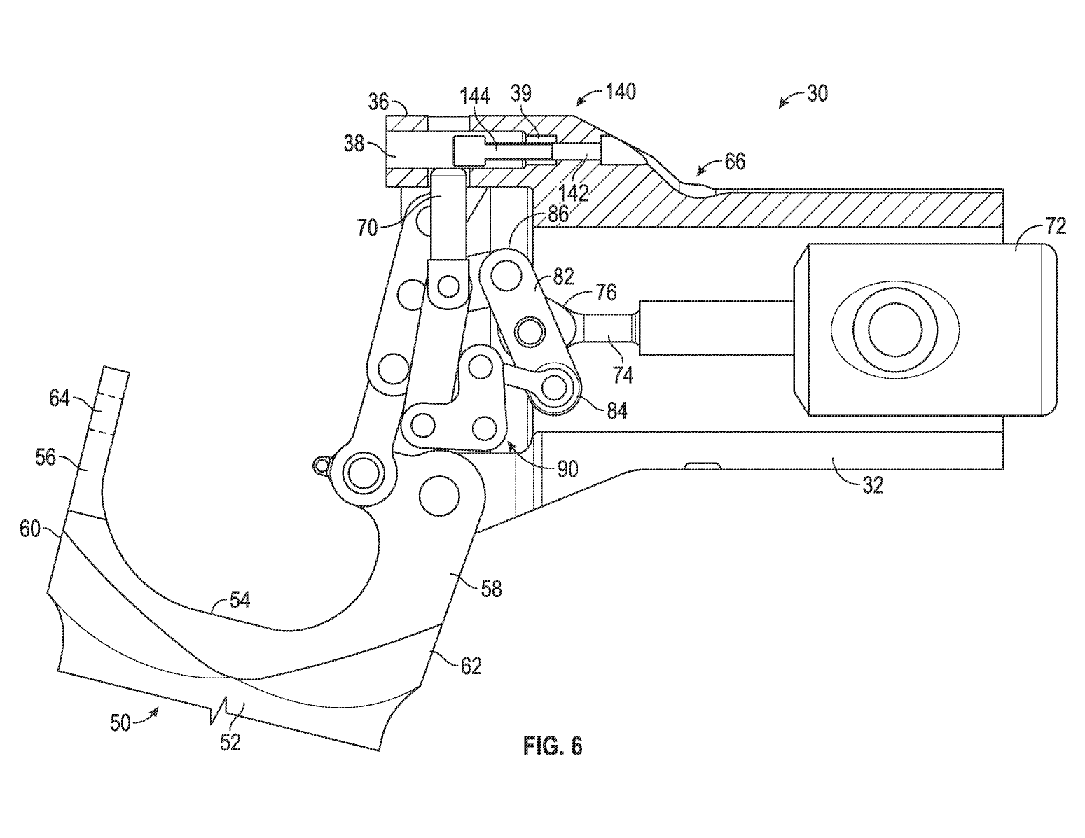

The second arm 58 of the blade spar 52 is pivotally coupled to the spindle 32, such as with a pin P1 for example, such that the blade spar 52 is configured to rotate a desired amount about the blade axis X between a substantially aligned position (FIG. 3) and a rotated position (FIG. 6). When the blade spar 52 is in the aligned position, such as when the rotary wing aircraft 10 is in flight for example, the first arm 56 of the blade spar 52 is received within the cavity 38 of the spindle 32. A second opening 64 is formed in the first arm 56 of the blade spar 52 such that when the first section 30 and the second section 50 of the rotor blade 28 are aligned, the first and second openings 40, 64 are similarly aligned. In one embodiment, the second opening 64 is similar in size and shape to the first opening 40 formed in the spindle 32.

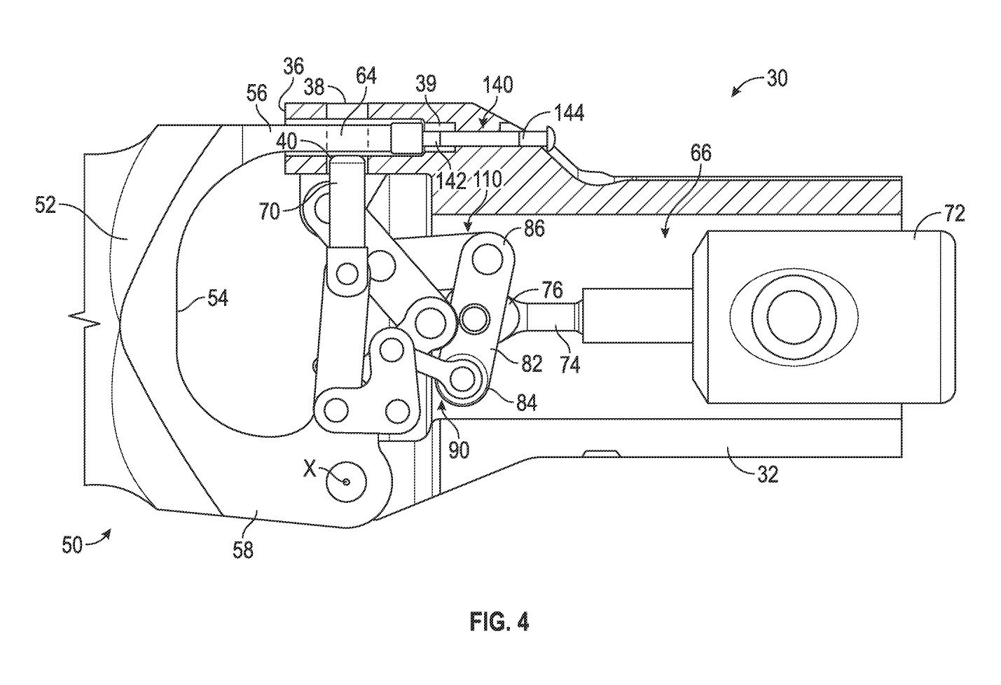

An actuation assembly 66 is mounted to a portion of the rotor blade 28, such as the first section 30 for example. The assembly 66 includes a locking pin 70 configured to move along an axis between an unlocked position (FIG. 4) and a locked position (FIG. 3). In the locked position, the locking pin 70 extends through the aligned first opening 40 and second opening 64 to restrict movement of the second section 50 of the rotor blade 28 about the blade fold axis X, thereby locking the first section 30 and second section 50 in an aligned orientation. When the locking pin 70 is in the unlocked position, the second section 50 of the rotor blade 28 is free to rotate about the blade fold axis X, away from the first section 30 of the rotor blade 28.

The actuation assembly 66 additionally includes an actuator 72, such as a linear actuator for example, and a linkage assembly 80 operably coupled to the second section 50 of the rotor blade 28 and the locking pin 70. In conjunction with the actuator 72, the linkage assembly 80 is configured not only to move the locking pin 70 between the unlocked position and the locked position, but also to rotate the second section 50 of the rotor blade 28 about the blade axis X. The linkage assembly 80 includes a toggle link 82 pivotally mounted an end 76 of the movable portion 74 of the actuator 72. A first group of links 90 connected to a first end 84 of the toggle link 82 is configured to move the locking pin 70 in and out of engagement with the spindle 32 and first arm 56 of the blade spar 52. A second group of links 110 connected to a second end 86 of the toggle link 82 is configured to pivot the blade spar 52 relative to the spindle 32 between the aligned and rotated positions. The first group of links 90 and the second group of links 110 are arranged such that upon operation of the actuator 72, the toggle link 82 is only free to pivot in one direction at any given time.

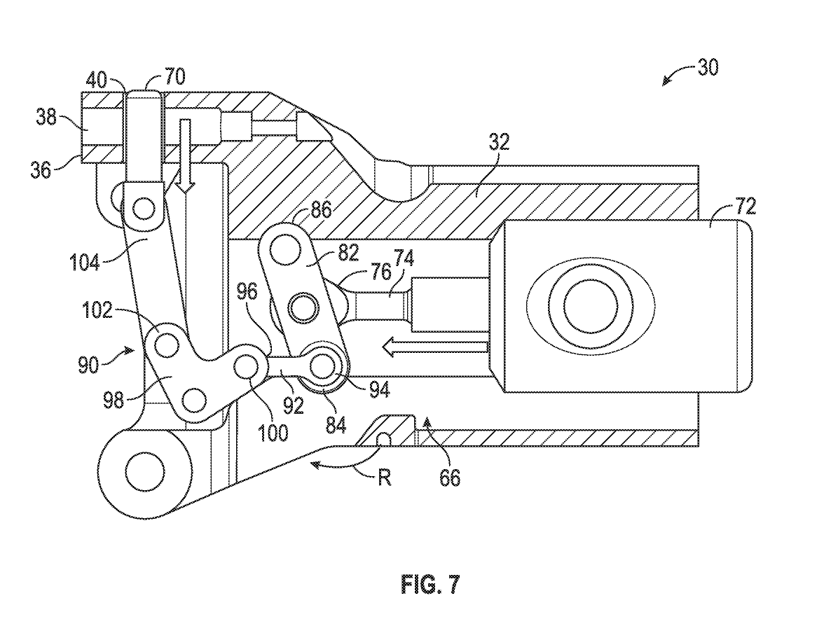

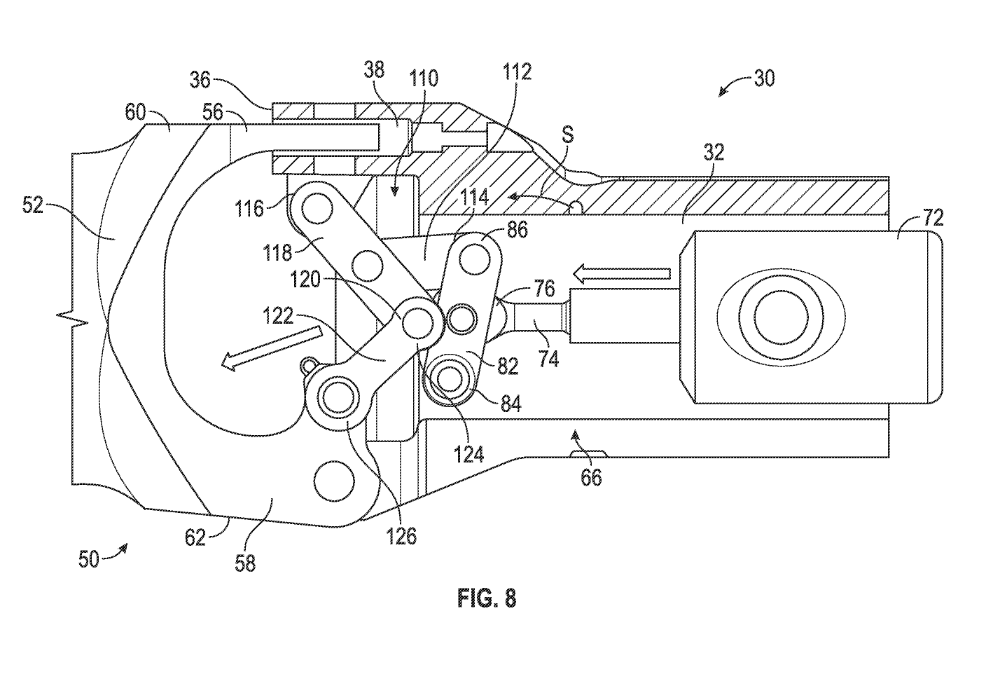

The first group of links 90, illustrated in FIG. 7, includes a first link 92, a first end 94 of the first link 92 is pivotally coupled to the toggle link 82 and a second end 96 of the first link 92 is coupled to a first end 100 of a second link 98. In one embodiment, the second link 98 has a generally bent or elbow-shaped configuration. A third link 104 connects the second end 102 of the second link 98 to the locking pin 70. The second group of links 110, shown in more detail in FIG. 8, includes a fourth link 112, a first end 114 of the fourth link 112 being pivotally coupled to the toggle link 82 and a second end 116 of the fourth link 114 being coupled to a portion of a fifth link 118. A sixth link 122 is coupled at a first end 124 to an end 120 of the fifth link 118, and is fastened at a second end 126 to a portion of the second arm 58 of the blade spar 52.

To rotate the second section 50 of the rotor blade 28 from the aligned position to a rotated position, the actuator 72 is operated in a first direction. As the piston 74 of the actuator 72 extends to a first position, the toggle link 82 rotates in a first direction, indicated by arrow R, causing the first group of links 90 to pivot such that the locking pin 70 slides generally sideways out of the first and second openings 40, 64. Further extension of the movable portion 74 of the actuator 72 from the first position to a second position, after the locking pin 70 has moved to the unlocked position, causes the toggle link 82 to rotate in a second opposite direction, indicated by arrow S, and the second group of links 110 to rotate accordingly. Because the sixth link 122 is fastened to the second arm 58 of the blade spar 52, rotation of the sixth link 122 causes the blade spar 52 to pivot about the blade fold axis X. Similarly, to rotate the second section 50 of the rotor blade 28 back to the aligned position, the initial retraction of the actuator piston 74 causes the second end 86 of the toggle link 82 to rotate in a direction opposite the direction indicated by arrow S until the first arm 56 of the blade spar 52 is received within the cavity 38 and the first and second openings 40, 64 are aligned. Further movement of the actuator 72 causes the toggle link 82 to rotate in a direction, opposite the direction indicated by arrow R, such that the locking pin 70 slidably extends through the aligned first and second opening 40, 64.

In one embodiment, illustrated in FIGS. 4-6, a blocking mechanism 140 is arranged at an interior end 39 of the cavity 38. The blocking mechanism 140 includes a plunger 142 positioned adjacent a biasing mechanism 144, such as a spring for example. When the first arm 56 of the blade spar 52 is positioned the cavity 38, the first arm 56 applies a force to the plunger 140, thereby compressing the biasing mechanism 144 so that the second opening 64 of the first arm 56 and the first opening 40 in the spindle 32 are aligned. As the actuator 72 moves and the first arm 56 of the blade spar 52 is rotated out of the cavity 38, the biasing force of the biasing mechanism 144 moves the plunger 142 to a neutral position. In the neutral position, at least a portion of the plunger 142 extends within the cavity 38 to restrict movement of the locking pin 70 through the first opening 40 when the first and second sections 30, 50 of the rotor blade 28 are not aligned.

Inclusion of the linkage assembly 80 in actuation assembly for a foldable rotor blade 28 eliminates the need for a second actuator. As a result, the complexity of the actuation assembly 66 and therefore the cost of the assembly is reduced. In addition, by eliminating the second actuator, the drag generated by the actuation assembly is improved. While shown with a particular linkage assembly, it is understood that other assemblies could be used to connect the single actuator 72 in a manner in which movement of the plunger 142 in a same direction results in unlocking and folding of the blade.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. By way of example, aspects could be used to fold fixed aircraft propellers and/or wings, turbine blades, or other items which are folded for purposes of saving space, transport, to protect from weather, or other like reasons. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An actuation assembly configured for use on a rotor blade having a first section and a second section, the second section being configured to rotate about a blade fold axis between an aligned position and a rotated position relative to the first section, the actuation assembly comprising:
an actuator having a movable portion configured to move in a first direction and a second, opposite direction;
a linkage assembly operably coupled to the movable portion of the actuator, the linkage assembly including:
a toggle link having a first end and a second end;
a first group of links coupled to the first end and which moves a locking pin between a locked position in which the second section cannot rotate and an unlocked position in which the second section can rotate; and
a second group of links coupled to the second end and which rotates the second section of the rotor blade between the aligned position and the rotated position while the locking pin is in the unlocked position.

2. The actuation assembly according to claim 1, wherein the actuator is a linear actuator.

3. The actuation assembly according to claim 1, wherein upon operation of the actuator, the toggle link is configured to move either the first group of links or the second group of links.

4. The actuation assembly according to claim 1, wherein when the locking pin is in a locked position, the second section of the rotor blade is retained in the aligned position.

5. The actuation assembly according to claim 1, wherein when the actuator is operated in a first direction, the toggle link is configured to move the first group of links and the second group of links sequentially.

6. The actuation assembly according to claim 5, wherein when the actuator is operated in a second direction, the toggle link is configured to move the second group of links and the first group of links sequentially.

7. A rotor blade which rotates about a rotor hub, the rotor blade comprising:
a first section configured to mount to the rotor hub, the first section including a cavity and a first opening extending perpendicular to and through the cavity;
a second section including a first arm having at least one second opening, the second section being rotatably coupled to the first section and configured to rotate about a blade fold axis between an aligned position and a rotated position, wherein when the second section is in the aligned position the first arm is arranged within the cavity such that the first opening and the second opening are generally aligned; and
an actuation assembly including:
an actuator having a movable portion configured to move in a first direction and a second, opposite direction;
a linkage assembly operably coupled to the movable portion of the actuator, the linkage assembly including:
a toggle link having a first end and a second end;
a first group of links coupled to the first end and which moves a locking pin between a locked position in which the second section cannot rotate and an unlocked position in which the second section can rotate; and
a second group of links coupled to the second end and which rotates the second section of the rotor blade between the aligned position and the rotated position while the locking pin is in the unlocked position.

8. The rotor blade according to claim 7, wherein the actuator is a linear actuator.

9. The rotor blade according to claim 7, wherein when the locking pin is in the locked position, the locking pin extends through the aligned first opening and the second opening.

10. The rotor blade according to claim 9, wherein the locking pin is configured to retain the second section of the rotor blade in the aligned position.

11. The actuation assembly according to claim 7, wherein upon operation of the actuator, the toggle link is configured to move either the first group of links or the second group of links.

12. The rotor blade according to claim 11, wherein the actuator is configured to move the second group of links only when the locking pin is in the unlocked position.

13. The rotor blade according to claim 11, wherein the actuator is configured to move the first group of links only when the second section is in the aligned position.

14. The rotor blade according to claim 7, further comprising a blocking mechanism arranged within the cavity, wherein when the blocking mechanism is in a neutral position, the block mechanism is configured to limit movement of the locking pin from the unlocked position to the locked position when the second section is in a rotated position.

15. The rotor blade according to claim 14, wherein the blocking mechanism includes:
a plunger configured to slide within the cavity; and
a biasing mechanism configured to bias the plunger to the neutral position.

16. A method of folding a rotor blade, the rotor blade having a first section and a second section, the second section being rotatably coupled to the first section and configured to rotate about a blade fold axis between an aligned position and a rotated position, the rotor blade additionally including an actuation assembly including an actuator coupled to a linkage assembly having a first group of links and a second group of links, comprising:
pivoting the first group of links to move a locking pin from a locked position in which the second section cannot rotate to an unlocked position in which the second section can rotate; and
rotating the second group of links to rotate the second section of the rotor blade about the blade axis from the aligned position to the rotated position.

17. The method according to claim 16, wherein a first movement of the actuator causes the first group of links to pivot and a second movement of the actuator causes the second group of links to pivot.

18. The method according to claim 16, further comprising:
pivoting the second group of links to rotate the second section of the rotor blade about the blade fold axis from the rotated position to the aligned position; and
rotating the first group of links to move the locking pin from the unlocked position to the locked position.
